(19) United States
(12) Patent Application Publication
(10) Pub. No.: US 2020/0315377 A1
(43) Pub. Date: Oct. 8, 2020

(54) IMAGE FRAME AND METHOD OF MANUFACTURING THE SAME

(71) Applicant: CORNING INCORPORATED, Corning, NY (US)

(72) Inventors: Hyungee Kim, Seoul (KR); Taehun Kim, Asan-si (KR); Je-choon Ryoo, Asan-si (KR)

(21) Appl. No.: 16/809,133

(22) Filed: Mar. 4, 2020

(30) Foreign Application Priority Data
Mar. 6, 2019 (KR) 10-2019-0025785

(51) Int. Cl. A47G 1/06; C03C 3/095; C03C 3/091; C03C 3/093; C03C 3/085; C03C 3/087; C08J 5/12; C08J 5/18; C09J 7/38; C09J 7/10; C09J 5/00; B32B 7/12; B32B 17/06; B32B 27/08; B32B 27/30; B32B 27/32; B32B 27/36; B32B 37/02; B32B 37/12; B32B 37/18; B32B 37/10; B32B 38/00

(52) U.S. Cl. CPC A47G 1/0638; B32B 2367/00; C03C 3/091; C03C 3/093; C03C 3/085; C03C 3/087; C08J 5/128; C08J 5/18; C09J 7/385; C09J 7/10; C09J 5/00; B32B 7/12; B32B 17/064; B32B 27/08; B32B 27/308; B32B 27/32; B32B 27/36; B32B 37/02; B32B 37/1207; B32B 37/182; B32B 37/10; B32B 38/145; C08J 2323/12; C08J 2367/02; C09J 2433/00; C09J 2400/146; C09J 2467/008; C09J 2423/108; B32B 2037/1223; B32B 2255/10; B32B 2307/412; B32B 2315/08; B32B 2323/10; B32B 2333/04; B32B 2451/00; C03C 3/095

(57) ABSTRACT

Provided is an image frame includes a polymer film including an image layer on a first main surface of the polymer film; a glass cover layer located over the first main surface of the polymer film with the image layer between the glass cover layer and the polymer film; and an adhesive film between the polymer film and the glass cover layer. The image frame may be displayed in more various forms without distortion and may be preserved long time without quality degradation.

### CROSS REFERENCE TO RELATED APPLICATION

This application claims the benefit of priority under 35 U.S.C. § 119 of Korean Patent Application No. 10-2019-0025785, filed Mar. 6, 2019, the content of which is incorporated herein by reference in its entirety.

### BACKGROUND

One or more embodiments relate to image frames and method of manufacturing the same, and more particularly, to an image frame that may be displayed in various forms without distortion and may be preserved long time without quality degradation, and a method of manufacturing the image frame.

Means for displaying image products that consider visual recognition as important, for example, pictures, paintings, and graphics, are needed. In particular, there is a demand for technology capable of displaying these image products in more various forms without distortion and preserving the image products long time without quality degradation.

### SUMMARY

One or more embodiments include an image frame that may be displayed in more various forms without distortion and may be preserved long time without quality degradation.

One or more embodiments include a method of manufacturing an image frame that may be displayed in more various forms without distortion and may be preserved long time without quality degradation.

Additional aspects will be set forth in part in the description which follows and, in part, will be apparent from the description, or may be learned by practice of the presented embodiments.

According to one or more embodiments, an image frame includes a polymer film including an image layer on a first main surface of the polymer film; a glass cover layer located over the first main surface of the polymer film with the image layer between the glass cover layer and the polymer film; and an adhesive film between the polymer film and the glass cover layer, wherein a cubic L-a-b gamut volume according to CIE L-a-b 1976 modeling is 340,000 or greater.

The glass cover layer may include: SiO₂ of 60 mol % to 70 mol %; Al₂O₃ of 6 mol % to 14 mol %; B₂O₃ of 0 mol % to 15 mol %; Li₂O of 0 mol % to 15 mol %; Na₂O of 0 mol % to 20 mol %; K₂O of 0 mol % to 10 mol %; MgO of 0 mol % to 8 mol %; CaO of 0 mol % to 10 mol %; ZrO₂ of 0 mol % to 5 mol %; SnO₂ of 0 mol % to 1 mol %; CeO₂ of 0 mol % to 1 mol %; As₂O₃ of less than 50 ppm; and Sb₂O₃ of less than 50 ppm, wherein 12 mol %≤(Li₂O+Na₂O+K₂O)≤20 mol %, and 0 mol %≤(MgO+CaO)≤10 mol %.

According to some embodiments, a difference between a maximum thickness and a minimum thickness of the glass cover layer may be less than about 0.03 mm. According to some embodiments, a surface of the glass cover layer opposite to a surface of the glass cover layer facing the adhesive film may have an unevenness of less than 0.03 mm. According to some embodiments, the polymer film may include a polypropylene (PP) film and a polyethylene terephthalate (PET) film. The polymer film may have a thickness of about 200 micrometers (μm) to about 350 μm.

According to some embodiments, the image frame may have a hue-saturation-lightness (HSL) gamut volume according to CIE L-a-b 1976 modeling of 750,000 or greater. According to some embodiments, the image frame may have a white point L value according to CIE L-a-b 1976 modeling of about 72 to about 74.

According to some embodiments, by attaching the glass cover layer, an HSL gamut volume according to CIE L-a-b 1976 modeling may increase 250,000 or greater compared with when the glass cover layer is not attached. According to some embodiments, by attaching the glass cover layer, a cubic L-a-b gamut volume according to CIE L-a-b 1976 modeling may decrease 100,000 or less compared with when the glass cover layer is not attached. According to some embodiments, by attaching the glass cover layer, a white point L value according to CIE L-a-b 1976 modeling may decrease 21 or less compared with when the glass cover layer is not attached.

According to one or more embodiments, an image frame includes a polymer film including an image layer on a first main surface of the polymer film; a glass cover layer located on the first main surface of the polymer film with the image layer between the glass cover layer and the polymer film; and an adhesive film between the polymer film and the glass cover layer, wherein a hue-saturation-lightness (HSL) gamut volume according to CIE L-a-b 1976 modeling is 750,000 or greater.

According to some embodiments, the adhesive film may be an acrylic adhesive film having a thickness of 90 μm to 130 μm. According to some embodiments, the adhesive film may originate from a stand-alone type solid film.

According to one or more embodiments, a method of manufacturing an image frame includes providing a polymer film over a first main surface of the polymer film, wherein the polymer film includes an image layer; attaching an adhesive film onto the image layer; and attaching a glass cover layer onto the adhesive film. The polymer film may include a stacked film of a polypropylene (PP) film and a polyethylene terephthalate (PET) film, and the adhesive film may be an acrylic adhesive film. In particular, the polymer film may include a PP-PET laminated film in which a PP film is stacked on both surfaces of a PET film.

According to some embodiments, the method may further include performing hot-pressing on the polymer film, the adhesive film, and the glass cover layer, after the attaching of the adhesive film onto the image layer and the attaching of the glass cover layer onto the adhesive film. The hot pressing may be performed at about 50° C. to about 90° C.

According to some embodiments, the providing of the polymer film over the first main surface of the polymer film may include transferring the image layer onto the first main surface. The transferring of the image layer may be performed by inkjet printing or laser printing.

According to some embodiments, the attaching of the adhesive film onto the image layer may be performed by rolling a surface of the adhesive film and the image layer by using a roller such that the surface of the adhesive film faces the image layer.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view of an image frame according to an embodiment of the present disclosure;

FIG. 2 is a lateral cross-sectional view of the image frame taken along line II-IP of FIG. 1,

FIG. 3 is a lateral cross-sectional view of an image frame according to another embodiment of the present disclosure;

FIG. 4 is a flowchart of a method of manufacturing an image frame, according to an embodiment of the present disclosure;

FIGS. 5A through 5D are lateral cross-sectional views illustrating the method of FIG. 4;

FIGS. 6 and 7 are 3D L-a-b diagrams indicating results of performing CIE L-a-b 1976 modeling with respect to the objects of References 1 and 2, respectively;

FIGS. 8 through 13 are 3D L-a-b diagrams indicating results of performing CIE L-a-b 1976 modeling with respect to the image frames of Embodiment 1 and Comparative Examples 1 through 5, respectively;

FIGS. 14 and 15 are graphs showing results of measuring the black and white density responses of the objects of References 3 and 4, respectively; and

FIGS. 16 through 21 are graphs showing results of measuring the black and white density responses of the image frames of Embodiment 2 and Comparative Examples 7 through 11, respectively.

### DETAILED DESCRIPTION

Hereinafter, the embodiments of the present disclosure will be described more fully with reference to the accompanying drawings, in which exemplary embodiments of the present disclosure are shown. The embodiments of the present disclosure may, however, be embodied in many different forms and should not be construed as limited to the exemplary embodiments set forth herein. Rather, these embodiments are provided so that the present disclosure will be thorough and complete, and will fully convey the scope of the present disclosure to those skilled in the art. Like numbers refer to like elements throughout the specification. Various elements and regions illustrated in the drawings are schematic in nature. Thus, embodiments of the present disclosure is not limited to relative sizes or intervals illustrated in the accompanying drawings.

While such terms as “first,” “second,” etc., may be used to describe various components, such components must not be limited to the above terms. The above terms are used only to distinguish one component from another. For example, a first component discussed below could be termed a second component, and similarly, a second component may be termed a first component without departing from the teachings of the present disclosure.

The terminology used herein is for the purpose of describing particular embodiments only, and is not intended to limit the present disclosure. An expression used in the singular encompasses the expression of the plural, unless it has a clearly different meaning in the context. It will be understood that the terms “comprises” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which embodiments of the present disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When a certain embodiment may be implemented differently, a specific process order may be performed differently from the described order. For example, two consecutively described processes may be performed substantially at the same time or performed in an order opposite to the described order.

As such, variations from the shapes of the illustrations as a result, for example, of manufacturing techniques and/or tolerances, are to be expected. Thus, embodiments of the present disclosure should not be construed as being limited to the particular shapes of regions illustrated herein but are to include deviations in shapes that result, for example, from manufacturing. As used herein, the term “and/or” includes any and all combinations of one or more of the associated listed items. Term “substrate” used in this specification may mean a substrate itself, or a stacked structure including a substrate and a layer or film formed on a surface of the substrate. Term “a surface of a substrate” used in this specification may mean an exposed surface of a substrate or an outer surface of a layer or film formed on the substrate.

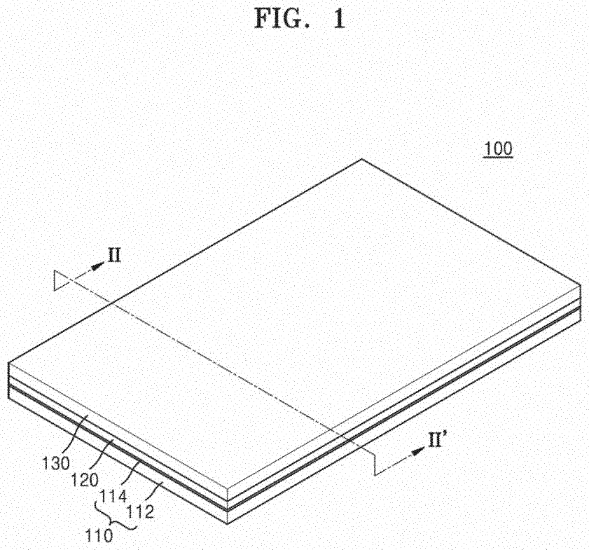

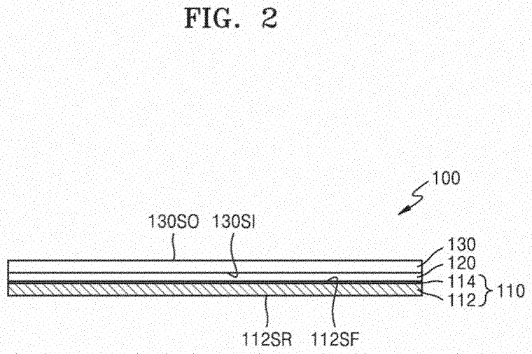

FIG. 1 is a perspective view of an image frame 100 according to an embodiment of the present disclosure. FIG. 2 is a lateral cross-sectional view of the image frame 100 taken along line II-IP of FIG. 1.

Referring to FIGS. 1 and 2, the image frame 100 includes a polymer film 110 including an image layer 114 on a first main surface 112SF of the polymer film 110; a glass cover layer 130 located on the first main surface 112SF of the polymer film 110 with the image layer 114 therebetween; and an adhesive film 120 between the polymer film 110 and the glass cover layer 130.

The polymer film 110 may include the image layer 114 on a base 112. The base 112 may include a laminate film in which two or more types of polymer resin layers are stacked on each other. According to some embodiments, the base 112 may include a polypropylene (PP) film and a polyethylene terephthalate (PET) film, or may include a stacked film of the PP film and the PET film. According to some embodiments, the base 112 may include a PP-PET laminate film in which a PP film is stacked on both surfaces of a PET film.

According to some embodiments, the polymer film 110 may further include other polymer resin layers in addition to the PP film and the PET film. For example, the polymer film 110 may further include other polymer resin layers including a polystyrene (PS) film, an acrylonitrile butadiene styrene (ABS) resin film, high density polyethylene (HDPE), low density polyethylene (LDPE), polyvinyl chloride (PVC), polyethylene naphthalate, polybutylene terephthalate, polycarbonate (PC), or a copolymer thereof.

The image layer 114 may be a printed layer on which arbitrary contents, such as characters, pictures, and symbols, are printed. The image layer 114 may be formed by, for example, inkjet printing or laser printing. The image layer 114 may include a pigment component of ink for inkjet printers, or a pigment component of toner for laser printers.

The polymer film 110 may have a thickness of about 100 micrometers (μm) to about 400 μm, about 150 μm to about 370 μm, or about 200 μm to about 350 μm. When the polymer film 110 is excessively thin, such as less than about 100 μm, the polymer film 110 may be difficult to handle, and thus productivity may degrade. On the other hand, when the polymer film 110 is excessively thick, such as greater than about 400 μm, it may be difficult to secure a good exterior of a product.

The glass cover layer 130 may be a strengthened glass sheet. The glass cover layer 130 may be a thermally- or chemically-strengthened glass sheet.

According to some embodiments, the glass cover layer 130 may be a glass sheet chemically strengthened by an ion exchange process. In the ion exchange process, the glass cover layer 130 may be chemically strengthened by dipping a glass sheet into a molten salt bath for a certain period of time and exchanging ions on a surface of the glass sheet or near the glass sheet with larger metal ions of molten salt. According to some embodiments, a temperature of the molten salt bath may be about 430° C., and a dipping time period may be about 8 hours.

Because the larger metal ions are included in the glass, a compressive stress is formed around a surface, and thus the glass cover layer 130 may be strengthened. At this time, a tensile stress corresponding to the compressive stress is induced within a center region of the glass cover layer 130, and thus a balance may be established. The present disclosure is not intended to be bound to a specific theory, but “ion exchange” may mean a process of exchanging positive ions on a surface of a glass sheet or near the glass sheet with other positive ions having the same atomic value as the former positive ions.

The glass cover layer 130 may include, for example, SiO₂, B₂O₃, and Na₂O, and (SiO₂+B₂O₃) may be equal to or greater than about 66 mol % and Na₂O may be equal to or greater than about 9 mol %. According to some embodiments, the glass cover layer 130 may include aluminum oxide of at least about 6% by weight. According to other embodiments, the glass cover layer 130 may further include one or more types of alkaline-earth oxides. In this case, the glass cover layer 130 may include alkaline-earth oxide of about 5% or greater by weight. According to some embodiments, the glass cover layer 130 may further include one or more types from among K₂O, MgO, and CaO. According to some embodiments, the glass cover layer 130 may include SiO₂ of about 61 mol % to about 75 mol %; Al₂O₃ of about 7 mol % to about 15 mol %; B₂O₃ of 0 mol % to about 12 mol %; Na₂O of about 9 mol % to about 21 mol %; K₂O of 0 mol % to about 4 mol %; MgO of 0 mol % to about 7 mol %; and CaO of 0 mol % to about 3 mol %.

According to some embodiments, the glass cover layer 130 may include SiO₂ of about 60 mol % to about 70 mol %; Al₂O₃ of about 6 mol % to about 14 mol %; B₂O₃ of 0 mol % to about 15 mol %; Li₂O of 0 mol % to about 15 mol %; Na₂O of 0 mol % to about 20 mol %; K₂O of 0 mol % to about 10 mol %; MgO of 0 mol % to about 8 mol %; CaO of 0 mol % to about 10 mol %; ZrO₂ of 0 mol % to about 5 mol %; SnO₂ of 0 mol % to about 1 mol %; CeO₂ of 0 mol % to about 1 mol %; As₂O₃ of less than about 50 ppm; and Sb₂O₃ of less than about 50 ppm. According to some embodiments, about 12 mol % may be less than or equal to (Li₂O+Na₂O+K₂O), and (Li₂O+Na₂O+K₂O) may be less than or equal to about 20 mol %. According to some embodiments, 0 mol % may be less than or equal to (MgO+CaO), and (MgO+CaO) may be less than or equal to about 10 mol %.

According to some embodiments, the glass cover layer 130 may include SiO₂ of about 63.5 mol % to about 66.5 mol %; Al₂O₃ of about 8 mol % to about 12 mol %; B₂O₃ of 0 mol % to about 3 mol %; Li₂O of 0 mol % to about 5 mol %; Na₂O of about 8 mol % to about 18 mol %; K₂O of 0 mol % to about 5 mol %; MgO of about 1 mol % to about 7 mol %; CaO of 0 mol % to about 2.5 mol %; ZrO₂ of 0 mol % to about 3 mol %; SnO₂ of about 0.05 mol % to about 0.25 mol %; CeO₂ of about 0.05 mol % to about 0.5 mol %; As₂O₃ of less than about 50 ppm; and Sb₂O₃ of less than about 50 ppm. According to some embodiments, about 14 mol % may be less than or equal to (Li₂O+Na₂O+K₂O), and (Li₂O+Na₂O+K₂O) may be less than or equal to about 18 mol %. According to some embodiments, about 2 mol % may be less than or equal to (MgO+CaO), and (MgO+CaO) may be less than or equal to about 7 mol %.

According to some embodiments, the glass cover layer 130 may include SiO₂ of about 58 mol % to about 72 mol %; Al₂O₃ of about 9 mol % to about 17 mol %; B₂O₃ of about 2 mol % to about 12 mol %; Na₂O of about 8 mol % to about 16 mol %; and K₂O of 0 mol % to about 4 mol %.

According to some embodiments, the glass cover layer 130 may include SiO₂ of about 61 mol % to about 75 mol %; Al₂O₃ of about 7 mol % to about 15 mol %; B₂O₃ of 0 mol % to about 12 mol %; Na₂O of about 9 mol % to about 21 mol %; K₂O of 0 mol % to about 4 mol %; MgO of 0 mol % to about 7 mol %; and CaO of 0 mol % to about 3 mol %.

According to other embodiments, the glass cover layer 130 may include SiO₂ of about 60 mol % to about 70 mol %; Al₂O₃ of about 6 mol % to about 14 mol %; B₂O₃ of 0 mol % to about 15 mol %; Li₂O of 0 mol % to about 15 mol %; Na₂O of 0 mol % to about 20 mol %; K₂O of 0 mol % to about 10 mol %; MgO of 0 mol % to about 8 mol %; CaO of 0 mol % to about 10 mol %; ZrO₂ of 0 mol % to about 5 mol %; SnO₂ of 0 mol % to about 1 mol %; CeO₂ of 0 mol % to about 1 mol %; As₂O₃ of less than about 50 ppm; and Sb₂O₃ of less than about 50 ppm, and 12 mol %≤Li₂O+Na₂O+K₂O≤20 mol % and 0 mol %≤MgO+CaO≤10 mol %.

According to other embodiments, the glass cover layer 130 includes SiO₂ of about 64 mol % to about 68 mol %; Na₂O of about 12 mol % to about 16 mol %; Al₂O₃ of about 8 mol % to about 12 mol %; B₂O₃ of 0 mol % to about 3 mol %; K₂O of about 2 mol % to about 5 mol %; MgO of about 4 mol % to about 6 mol %; and CaO of 0 mol % to about 5 mol %, and about 66 mol %≤(SiO₂+B₂O₃+CaO)≤about 69 mol %; (N₂O+K₂O+B₂O₃+MgO+CaO+SrO)>about 10 mol %; about 5 mol %≤(MgO+CaO+SrO)≤about 8 mol %; (N₂O+B₂O₃)—Al₂O₃≤about 2 mol %; 2 mol %≤(Na₂O—Al₂O₃)≤about 6 mol %; and about 4 mol %≤(Na₂O+K₂O)—Al₂O₃≤about 10 mol %.

A lower limit of a content range of a certain component within the above numerical ranges being 0 means that the component may be included or may not be included.

According to some embodiments, the glass cover layer 130 may have a thickness of less than about 3.0 mm. According to some embodiments, the glass cover layer 130 may have a thickness of about 0.5 mm to about 3.0 mm, about 0.7 mm to about 2.5 mm, about 0.8 mm to about 2.0 mm, about 0.5 mm to about 1.0 mm, about 1.0 mm to about 2.0 mm, or about 1.0 mm to about 1.5 mm.

According to some embodiments, a difference between a maximum thickness and a minimum thickness of the glass cover layer 130 may be less than about 0.03 mm. When the difference between the maximum thickness and the minimum thickness of the glass cover layer 130 is equal to or greater than about 0.03 mm, a visual image of the image layer 114 may be optically distorted.

According to some embodiments, the glass cover layer 130 may have an inner main surface 130SI facing the adhesive film 120, and an outer main surface 130SO being a main surface opposite to the inner main surface 130SI. The outer main surface 130SO may have irregularity of less than about 0.03 mm. When the outer main surface 130SO has irregularity of about 0.03 mm or greater, the visual image of the image layer 114 may be optically distorted.

The glass cover layer 130 may have a thickness of about 0.5 mm to about 2.2 mm, about 0.6 mm to about 2.0 mm, about 0.7 mm to about 1.8 mm, about 0.8 mm to about 1.6 mm, or about 0.9 mm to about 1.4 mm.

The glass cover layer 130, which is obtainable for common use, may include, for example, Gorilla® glass manufactured by Corning Incorporated. The Gorilla® glass may be one of, for example, Gorilla Glass 3, Gorilla Glass 4, Gorilla Glass 5, Gorilla Glass SR+, and Gorilla Glass 6, but the embodiments of the present disclosure are not limited thereto.

According to some embodiments, the adhesive film 120 may be so called an optical clear adhesive (OCA) film. The adhesive film 120 may be, for example, an acrylic OCA film. Examples of an OCA film obtainable for common use include 8146-x series manufactured by 3M, 8215 series manufactured by 3M, QX series manufactured by TMS, WMH series manufactured by TMS, NW series manufactured by TMS, WMS series manufactured by TMS, and US series manufactured by TMS.

The thickness of the adhesive film 120 may be about 25 μm to about 320 μm, about 25 μm to about 250 μm, about 25 μm to about 130 μm, about 25 μm to about 100 μm, about 25 μm to about 80 μm, about 25 μm to about 70 μm, about 25 μm to about 60 μm, about 40 μm to about 320 μm, about 40 μm to about 250 μm, about 40 μm to about 130 μm, about 40 μm to about 100 μm, about 40 μm to about 80 μm, about 40 μm to about 70 μm, about 40 μm to about 60 μm, about 65 μm to about 320 μm, about 65 μm to about 250 μm, about 65 μm to about 130 μm, about 65 μm to about 100 μm, about 65 μm to about 80 μm, about 90 μm to about 320 μm, about 90 μm to about 250 μm, about 90 μm to about 130 μm, or about 90 μm to about 100 μm. When the polymer film 120 is excessively thin, such as less than about 25 μm, the polymer film 120 may be difficult to handle, and thus productivity may degrade. On the other hand, when the polymer film 120 is excessively thick, such as greater than about 320 μm, the visual image of the image layer 114 may be distorted.

The image frame 100 may have unique optical characteristics. According to some embodiments, the image frame 100 may have a hue-saturation-lightness (HSL) gamut volume according to CIE L-a-b 1976 modeling of 750,000 or greater. According to some embodiments, the image frame 100 may have a cubic L-a-b gamut volume according to CIE L-a-b 1976 modeling of 340,000 or greater. When the HSL gamut volume is 750,000 or greater and/or the cubic L-a-b gamut volume is 340,000, a more visually rich and vivid color may be recognized.

The CIE L-a-b 1976 modeling may be performed on a sampling color patch by using a spectrum photometer after the image frame 100 is manufactured to include the sampling color patch. The sampling color patch may be a regular arrangement of, for example, 400 or more types of colors, 600 or more types of colors, 800 or more types of colors, or 1000 or more types of colors.

The HSL gamut volume and the cubic L-a-b gamut volume may be calculated using software, based on a result of the CIE L-a-b 1976 modeling.

Compared with when the image frame 100 does not include the glass cover layer 130, when the glass cover layer 130 is attached, the HSL gamut volume tends to increase and the cubic L-a-b gamut volume tends to decrease.

In other words, an HSL gamut volume obtained by performing CIE L-a-b 1976 modeling on the polymer film 110 on which an image has been printed without attaching the glass cover layer 130 increases more than an HSL gamut volume obtained by performing CIE L-a-b 1976 modeling on the image frame 100 completed by attaching up to the glass cover layer 130 onto the polymer film 110 on which an image has been printed. Compared with when the image frame 100 does not include the glass cover layer 130, when the glass cover layer 130 is attached, the HSL gamut volume may increase about 250,000 or greater.

However, a cubic L-a-b gamut volume obtained by performing CIE L-a-b 1976 modeling on the polymer film 110 on which an image has been printed without attaching the glass cover layer 130 decreases more than a cubic L-a-b gamut volume obtained by performing CIE L-a-b 1976 modeling on the image frame 100 completed by attaching up to the glass cover layer 130 onto the polymer film 110 on which an image has been printed. Compared with when the image frame 100 does not include the glass cover layer 130, when the glass cover layer 130 is attached, the cubic L-a-b gamut volume may decrease at most about 100,000.

According to some embodiments, the image frame 100 may have a white point L value according to CIE L-a-b 1976 modeling of about 72 or greater. For example, the white point L value may be about 72 to about 74. When the white point L value is less than 72, a brightness contrast of an image that is visually recognized is insufficient, and thus the quality of the image that is visually recognized may degrade.

Compared with when the image frame 100 does not include the glass cover layer 130, when the glass cover layer 130 is attached, the white point L value tends to decrease. Compared with when the image frame 100 does not include the glass cover layer 130, when the glass cover layer 130 is attached, the white point L value may decrease to at most about 21.

The image frame 100 may have a maximum black and white density of 2.03 or greater. The maximum black and white density may be measured as follows. First, the image frame 100 is manufactured to include a gray scale patch, and then a variation in an output density of the gray scale patch with respect to an input density thereof may be measured using a spectrum photometer. Thereafter, a maximum black and white density may be calculated from the variation in the output density of the gray scale patch with respect to the input density thereof by using software.

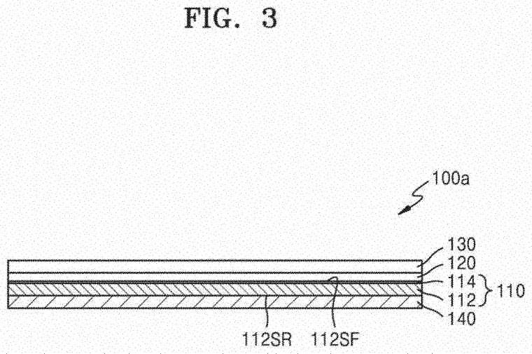

FIG. 3 is a lateral cross-sectional view of an image frame 100a according to another embodiment of the present disclosure. The image frame 100a of FIG. 3 is different from the image frame 100 described above with reference to FIGS. 1 and 2 in that a reinforced film 140 is further included. This difference will now be focused and described.

Referring to FIG. 3, the reinforced film 140 may be further provided on the second main surface 112SR of the polymer film 110. The reinforced film 140 may contribute to preventing damage to the image frame 100, such as the image frame 100 being scratched, and preventing contamination.

The reinforced film 140 may be, for example, an aluminum composite film. According to some embodiments, the reinforced film 140 may be a film in which a layer of PP, polyethylene (PE), PET, polybutene, ethylene/vinyl acetate (EVA), or a copolymer thereof is combined on an aluminum layer.

The reinforced film 140 may have a thickness of about 1.0 mm or less. According to some embodiments, the reinforced film 140 may have a thickness of about 0.1 mm to about 1.0 mm, about 0.2 mm to about 0.9 mm, about 0.3 mm to about 0.8 mm, about 0.4 mm to about 0.7 mm, or about 0.4 mm to about 0.6 mm.

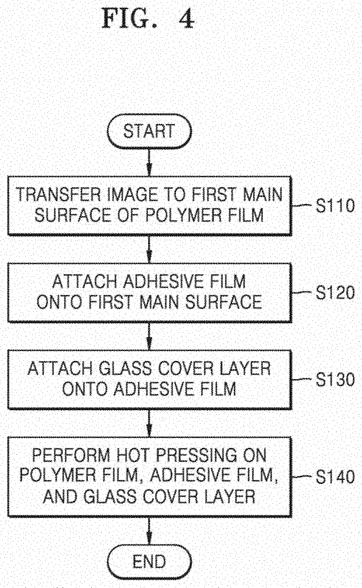

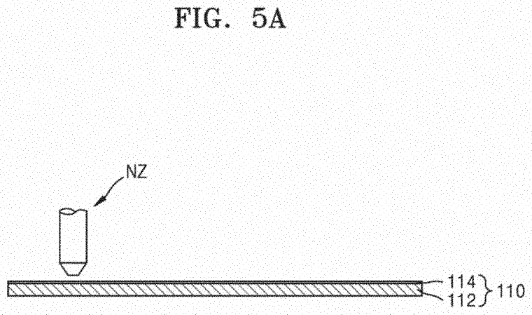

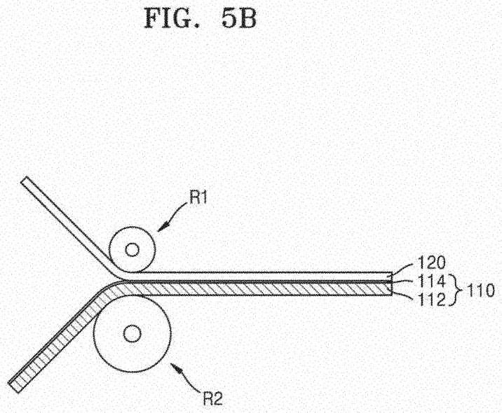

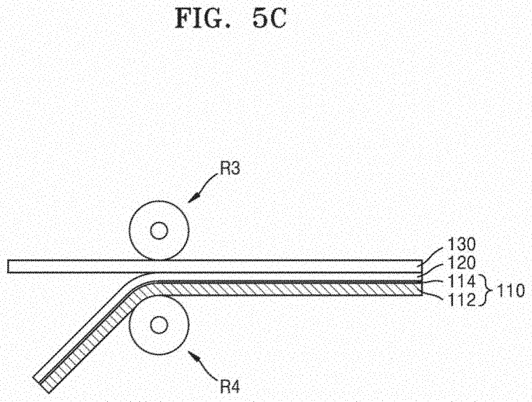

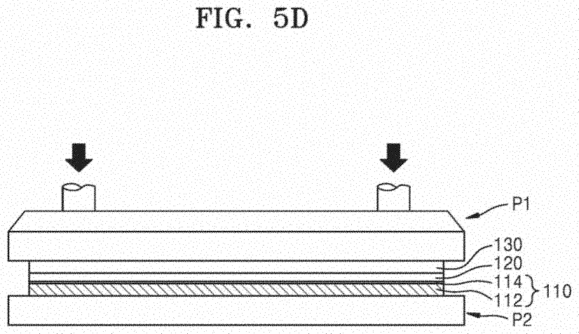

FIG. 4 is a flowchart of a method of manufacturing the image frame 100, according to an embodiment of the present disclosure. FIGS. 5A through 5D are lateral cross-sectional views illustrating the method of FIG. 4.

Referring to FIGS. 4 and 5A, the image layer 114 is formed on the first main surface 112SF of the polymer film 110, in operation S110. The image layer 114 may be formed by printing a desired image on the base 112 via, for example, inkjet printing or laser printing. Although inkjet printing via a nozzle NZ is illustrated in FIG. 5A, the embodiments of the present disclosure are not limited thereto.

Referring to FIGS. 4 and 5B, the adhesive film 120 may be attached onto the first main surface 112SF of the polymer film 110, in operation S120. The adhesive film 120 has been described above with reference to FIG. 2, and thus a redundant description thereof will be omitted. However, the adhesive film 120 is a stand-alone type solid film, not a fluid resin type adhesive like a liquid or a paste. Accordingly, before the adhesive film 120 is attached onto the polymer film 110, releasing films may have been attached onto both surfaces of the adhesive film 120, respectively.

The adhesive film 120 may adhere onto the first main surface 112SF by first and second rollers R1 and R2. In detail, the adhesive film 120 and the polymer film 110 may be smoothly attached to each other without bubbles, wrinkles, and other defects by closely adhering to each other by the first and second rollers R1 and R2. The adhesive film 120 and the polymer film 110 may be attached to each other at a room temperature or a temperature increased to about 40° C. to about 60° C. According to some embodiments, curing such as ultraviolet (UV) radiation may be further performed.

In FIG. 5B, only the adhesive film 120 is illustrated for simple and clear explanation, and a releasing film provided on a surface of the adhesive film 120 facing the first roller R1 is not illustrated.

Referring to FIGS. 4 and 5C, the glass cover layer 130 may be attached onto the adhesive film 120, in operation S130. The glass cover layer 130 has been described above with reference to FIG. 2, and thus a redundant description thereof will be omitted.

The glass cover layer 130 may adhere onto the adhesive film 120 by third and fourth rollers R3 and R4. In detail, the glass cover layer 130 and the adhesive film 120 may be smoothly attached to each other without bubbles, wrinkles, and other defects by closely adhering to each other by the third and fourth rollers R3 and R4. The glass cover layer 130 and the adhesive film 120 may be attached to each other at a room temperature or a temperature increased to about 40° C. to about 60° C. According to some embodiments, curing such as UV radiation may be further performed.

Optionally, as shown in FIGS. 4 and 5D, the polymer film 110, the adhesive film 120, and the glass cover layer 130 may undergo hot pressing, in operation S140. The hot pressing may be performed at a temperature increased to, for example, about 50° C. to about 90° C., and may be performed by applying a pressure of about 10 kPa to about 1000 kPa for about 1 second to about 30 seconds. The hot pressing may be performed by locating a workpiece in which the polymer film 110, the adhesive film 120, and the glass cover layer 130 are stacked on each other, on a lower platen P2, locating an upper platen P1 on the workpiece, and then manipulating the upper platen P1 and the lower platen P2 into increasing in temperature and pressurizing each other.

According to some embodiments, the hot pressing may not be performed.

Although structures and effects of embodiments of the present disclosure will now be described in detail with detailed embodiments and comparative examples, these embodiments are only for better understanding of the present disclosure and are not intended to limit the scope of the present disclosure.

### Reference 1

Reference 1 was obtained by printing, by using an inkjet printer, a sampling color patch for CIE L-a-b 1976 modeling on a polymer film in which PP, PET, and PP are stacked on each other in this stated order.

### Reference 2

Reference 2 was obtained by printing the same sampling color patch as that used for Reference 1 on paper instead of the polymer film.

### Embodiment 1

Similar to Reference 1, a sampling color patch for CIE L-a-b 1976 modeling was printed on a polymer film in which PP, PET, and PP are stacked on each other in this stated order by using an inkjet printer, and then an OCA film was attached onto the sampling color patch according to a rolling method. As the OCA film, 8215, manufactured by 3M, with a thickness of 125 μm was used.

Then, an image frame was manufactured by attaching Gorilla® glass, manufactured by Corning Incorporated, with a thickness of 1.1 mm, as a glass cover layer, onto the OCA film by using a rolling method.

### Comparative Example 1

An image frame was manufactured the same as Embodiment 1 except that an acryl resin substrate with a thickness of 3.0 mm instead of a glass cover layer is attached.

### Comparative Example 2

An image frame was manufactured the same as Embodiment 1 except that a soda lime glass with a thickness of 3.0 mm instead of a glass cover layer is attached.

### Comparative Example 3

An image frame was manufactured the same as Embodiment 1 except that a sampling color patch is printed on paper instead of a polymer film.

### Comparative Example 4

An image frame was manufactured the same as Comparative Example 1 except that a sampling color patch is printed on paper instead of a polymer film.

### Comparative Example 5

An image frame was manufactured the same as Comparative Example 2 except that a sampling color patch is printed on paper instead of a polymer film.

### Comparative Example 6

An image frame was attempted to be manufactured using, as a glass cover layer, a soda lime glass with a thickness of 1.5 mm instead of Gorilla® glass according to the same method as Embodiment 1. However, during a rolling process for attaching soda lime glass, the soda lime glass was destroyed, and manufacturing an image frame was impossible.

CIE L-a-b 1976 modeling was performed with respect to objects of References 1 and 2, Embodiment 1, and Comparative Examples 1 through 6 by using a spectrum photometer, and a result of the CIE L-a-b 1976 modeling was written in a three-dimensional (3D) L-a-b diagram, where an L axis being a vertical axis indicates brightness representing from a darkest color (black) to a brightest color (white), and a axis and b axis defining a horizontal plane indicate blue-to-yellow and magenta-to-green, respectively.

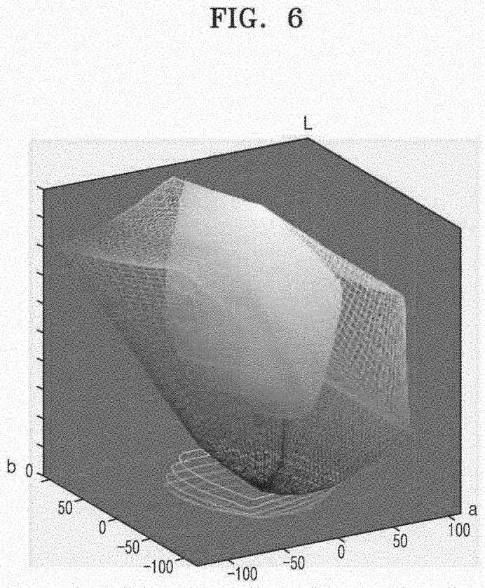

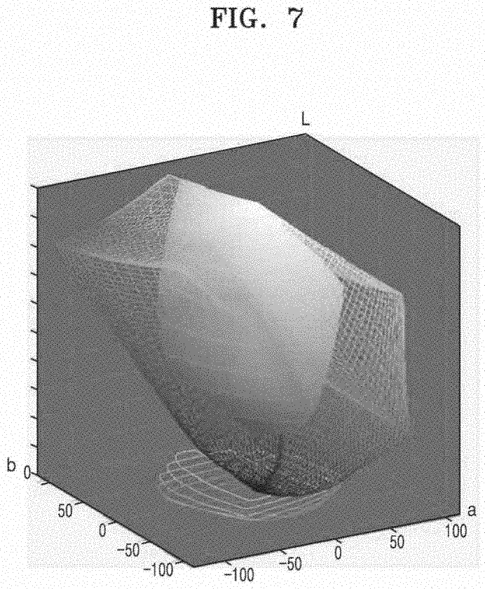

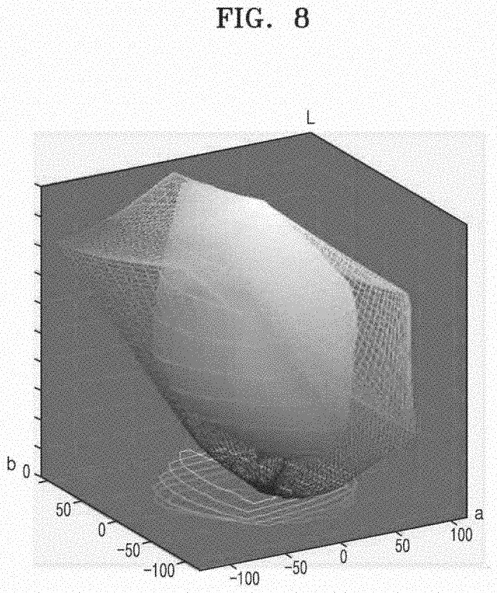

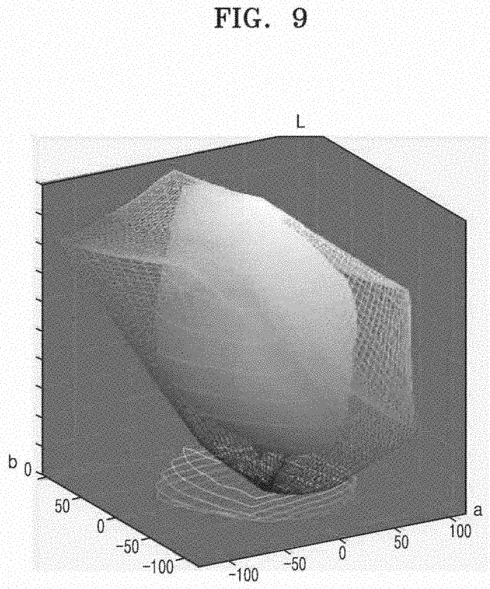

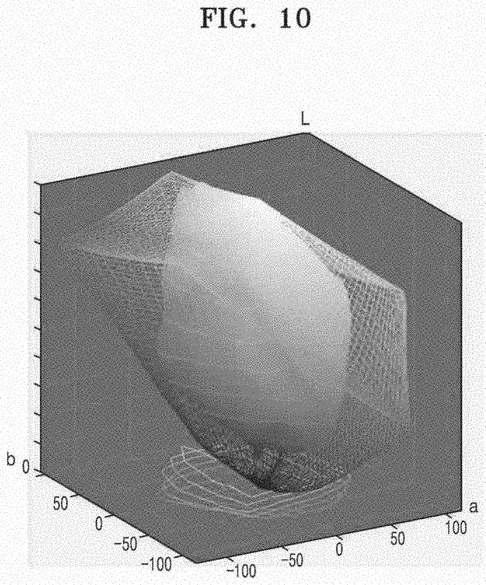

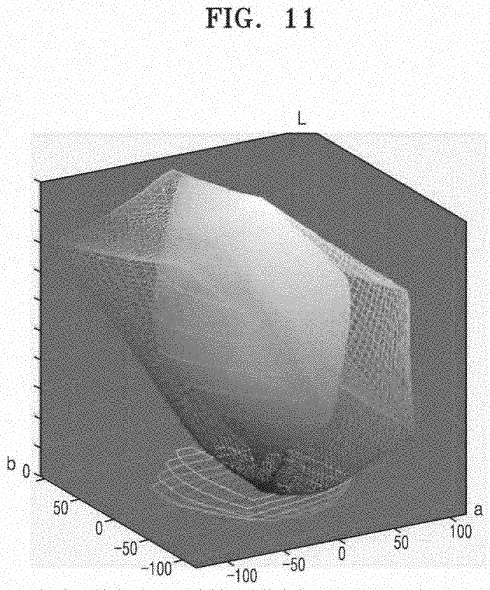

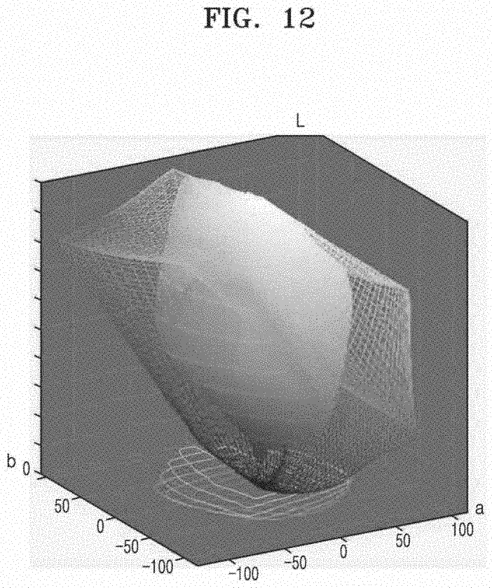

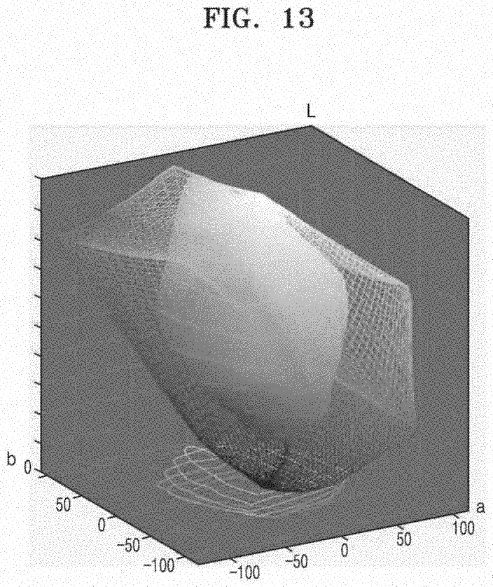

FIGS. 6 and 7 are 3D L-a-b diagrams indicating results of performing CIE L-a-b 1976 modeling with respect to the objects of References 1 and 2, respectively. FIGS. 8 through 13 are 3D L-a-b diagrams indicating results of performing CIE L-a-b 1976 modeling with respect to the image frames of Embodiment 1 and Comparative Examples 1 through 5, respectively.

### 1. Measurement of HSL Gamut Volume

CIE L-a-b 1976 modeling was performed on the objects of References 1 and 2, Embodiment 1, and Comparative Examples 1 through 5, and HSL gamut volumes were measured.

The measured HSL gamut volumes are expressed in Table 1. An HSL gamut volume may be represented by the area of a cross-section taken at a location where a hue is maximum (i.e., S=1).

TABLE 1

| | | | | | Increasing |
|---|---|---|---|---|---|
| | | | | | Rate with |
| | | | | HSL gamut | respect to |
| | Layer 1 | Layer 2 | Adhesive | volume | Reference (%) |
| Reference 1 | polymer film | — | — | 503,111 | — |
| Embodiment 1 | polymer film | Gorilla Glass | 3M 8215 | 769,368 | 53 |
| Comparative Example 1 | polymer film | Acyl Resin | 3M 8215 | 741,239 | 47 |
| Comparative Example 2 | polymer film | Soda Lime Glass | 3M 8215 | 698,354 | 39 |
| Reference 2 | paper | — | — | 573,311 | — |
| Comparative Example 3 | paper | Gorilla Glass | 3M 8215 | 672,384 | 17 |
| Comparative Example 4 | paper | Acryl Resin | 3M 8215 | 651,805 | 14 |
| Comparative Example 5 | paper | Soda Lime Glass | 3M 8215 | 555,741 | −1 |

Referring to Table 1, when Reference 1 is compared with Reference 2, an HSL gamut volume of Reference 2 in which printing was performed on paper is greater than that of Reference 1 in which printing was performed on a polymer film.

It was discovered that HSL gamut volumes of image frames respectively obtained by attaching Gorilla Glass, acryl resin, and soda lime glass onto each reference greatly vary according to references. In other words, when image frames are manufactured by attaching Gorilla Glass, acryl resin, and soda lime glass onto paper, respectively (i.e., Comparative Examples 3 through 5), HSL gamut volumes of the image frames slightly increase or rather decrease. On the other hand, when image frames are manufactured by attaching Gorilla Glass, acryl resin, and soda lime glass onto a polymer film, respectively (i.e., Embodiment 1 and Comparative Examples 1 and 2), HSL gamut volumes of the image frames greatly increase. Consequently, it was discovered that Reference 2 has higher HSL gamut volume than Reference 1 when references are compared with each other, but image frames manufactured by attaching transparent bases (Gorilla Glass, acryl resin, and soda lime glass) on Reference 1, respectively, have greater HSL gamut volumes than image frames manufactured by attaching the transparent bases on Reference 2, respectively.

In particular, Embodiment 1 of manufacturing an image frame by attaching Gorilla Glass onto a polymer film provided a greatest HSL gamut volume. An effect in which, as an HSL gamut volume increases, the range of colors capable of being expressed increases is obtained.

### 2. Measurement of Cubic L-a-b Gamut Volume

Cubic L-a-b gamut volumes of the objects of References 1 and 2, Embodiment 1, and Comparative Examples 1 through 5 were measured. The cubic L-a-b gamut volumes may be represented by volumes of inner curved surfaces illustrated in FIGS. 6 through 13, and were measured using a result of previously-performed CIE L-a-b 1976 modeling. The measured cubic L-a-b gamut volumes are expressed as in Table 2.

TABLE 2

| | | | | | Decreasing |
|---|---|---|---|---|---|
| | | | | | Rate with |
| | | | | cubic L-a-b | respect to |
| | Layer 1 | Layer 2 | Adhesive | gamut volume | Reference (%) |
| Reference 1 | polymer film | — | — | 445,352 | — |
| Embodiment 1 | polymer film | Gorilla Glass | 3M 8215 | 348,460 | 22 |
| Comparative Example 1 | polymer film | Acryl Resin | 3M 8215 | 220,219 | 51 |
| Comparative Example 2 | polymer film | Soda Lime Glass | 3M 8215 | 77,513 | 83 |
| Reference 2 | paper | — | — | 531,680 | — |
| Comparative Example 3 | paper | Gorilla Glass | 3M 8215 | 318,067 | 40 |
| Comparative Example 4 | paper | Acryl Resin | 3M 8215 | 192,911 | 64 |
| Comparative Example 5 | paper | Soda Lime Glass | 3M 8215 | 65,863 | 88 |

Referring to Table 2, when each of the transparent bases (Gorilla Glass, acryl resin, and soda lime glass) is attached onto each reference, a cubic L-a-b gamut volume decreases. When Reference 1 is compared with Reference 2, the cubic L-a-b gamut volume of Reference 2 in which printing was performed on paper is greater than that of Reference 1 in which printing was performed on a polymer film.

It was discovered that cubic L-a-b gamut volumes of image frames obtained by attaching Gorilla Glass, acryl resin, and soda lime glass onto each reference, respectively, greatly vary according to references. In other words, when image frames are manufactured by attaching Gorilla Glass, acryl resin, and soda lime glass onto paper, respectively (i.e., Comparative Examples 3 through 5), cubic L-a-b gamut volumes were reduced more than when image frame were manufactured by attaching Gorilla Glass, acryl resin, and soda lime glass onto a polymer film, respectively (i.e., Embodiment 1 and Comparative Examples 1 and 2). In other words, it was discovered that the cubic L-a-b gamut volumes of the image frames of Embodiment 1 and Comparative Examples 1 and 2 were greater than those of the image frames of Comparative Examples 3 through 5.

Among the image frames manufactured by attaching the transparent bases (Gorilla Glass, acryl resin, and soda lime glass), respectively, the image frame manufactured by attaching Gorilla Glass onto a polymer film in Embodiment 1 had a greatest cubic L-a-b gamut volume, and provided a smallest reduction rate of a cubic L-a-b gamut volume with respect to each reference. An effect in which, as reduction of a cubic L-a-b gamut volume decreases, the range of colors capable of being expressed widens is obtained.

### 3. Measurement of White Point L Value

White point L values of the objects of References 1 and 2, Embodiment 1, and Comparative Examples 1 through 5 were measured. The white point L values may be represented by locations, on the vertical axis, of the vertexes of the inner curved surfaces illustrated in FIGS. 6 through 13, and were measured using the result of the previously-performed CIE L-a-b 1976 modeling. The measured white point L values are expressed as in Table 3.

TABLE 3

| | | | | | Decreasing |
|---|---|---|---|---|---|
| | | | | | Rate with |
| | | | | | respect to |
| | Layer 1 | Layer 2 | Adhesive | white point | Reference (%) |
| Reference 1 | polymer film | — | — | 93.4271407 | — |
| Embodiment 1 | polymer film | Gorilla Glass | 3M 8215 | 72.4281075 | 22 |
| Comparative Example 1 | polymer film | Acryl Resin | 3M 8215 | 61.009293 | 35 |
| Comparative Example 2 | polymer film | Soda Lime Glass | 3M 8215 | 41.2007892 | 56 |
| Reference 2 | paper | — | — | 96.2295856 | — |
| Comparative Example 3 | paper | Gorilla Glass | 3M 8215 | 73.8842958 | 23 |
| Comparative Example 4 | paper | Acryl Resin | 3M 8215 | 61.5186426 | 36 |
| Comparative Example 5 | paper | Soda Lime Glass | 3M 8215 | 41.4544384 | 57 |

Referring to Table 3, when each of the transparent bases (Gorilla Glass, acryl resin, and soda lime glass) is attached onto each reference, a white point L value decreases.

It was confirmed that white point L values of image frames obtained by attaching Gorilla Glass, acryl resin, and soda lime glass onto each reference, respectively, decreased compared with each reference. It was also confirmed that, when Gorilla Glass is used (Embodiment 1 and Comparative Example 3), a reduction ratio of the white point L value was less than that when acryl resin or soda lime glass is used (Comparative Examples 1, 2, 4, and 5). In detail, in Embodiment 1 and Comparative Example 3, a reduction in a white point L value was about 22% compared with each reference. On the other hand, the image frames of Comparative Examples 1, 2, 4, and 5 provided a reduction in the white point L value of about 35% to about 57% compared with each reference.

### 4. A-b Saturation Gamut Map (S=1)

Areas of saturation gamuts according to various lightnesses (L=0.5, 0.7, 0.9) when a saturation is maximum (S=1) were measured for each of the objects of References 1 and 2, Embodiment 1, and Comparative Examples 1 through 5. The areas of saturation gamuts in the a-b saturation gamut map may be obtained by mapping the inner curved surfaces illustrated in FIGS. 6 through 13 on an a-b plane such that a saturation is maximum (S=1) and lightness L is 0.5, 0.7, and 0.9, and the measured areas of the saturation gamuts are summarized in Table 4.

TABLE 4

| | Layer 1 | Layer 2 | Adhesive | L = 0.5 | L = 0.7 | L = 0.9 |
|---|---|---|---|---|---|---|
| Reference 1 | polymer film | — | — | 18505 | 6031 | 683 |
| Embodiment 1 | polymer film | Gorilla Glass | 3M 8215 | 20006 | 4442 | 370 |
| Comparative Example 1 | polymer film | Acyl Resin | 3M 8215 | 19403 | 4147 | 336 |
| Comparative Example 2 | polymer film | Soda Lime Glass | 3M 8215 | 15890 | 4043 | 326 |
| Reference 2 | paper | — | — | 17063 | 5806 | 570 |
| Comparative Example 3 | paper | Gorilla Glass | 3M 8215 | 18770 | 4212 | 317 |
| Comparative Example 4 | paper | Acyl Resin | 3M 8215 | 18373 | 4005 | 286 |
| Comparative Example 5 | paper | Soda Lime Glass | 3M 8215 | 16819 | 3796 | 280 |

Referring to Table 4, a saturation gamut of Embodiment 1 was widest when L=0.5. When L=0.7 and L=0.9, a saturation gamut of Embodiment 1 was narrower than References 1 and 2, but was wider than Comparative Examples 1 through 5. Accordingly, the image frame of Embodiment 1 may express richer colors than the image frames of Comparative Examples 1 through 5.

### 5. a-b Saturation Map (L=0.5)

Areas of gamuts according to various saturations (S=0.2, 0.4, 0.6, 0.8, 1.0) when lightness L is 0.5 (L=0.5) were measured for each of the objects of References 1 and 2, Embodiment 1, and Comparative Examples 1 through 5. The areas of gamuts according to saturations in the a-b saturation map may be represented by the areas of horizontal cross-sections taken along L=0.5 planes of the inner curved surfaces illustrated in FIGS. 6 through 13, and the measured areas of the gamuts are expressed in Table 5.

TABLE 5

| | Layer 1 | Layer 2 | Adhesive | S = 0.2 | S = 0.4 | S = 0.6 | S = 0.8 | S = 1.0 |
|---|---|---|---|---|---|---|---|---|
| Reference 1 | polymer film | — | — | 490 | 2191 | 5427 | 10320 | 16050 |
| Embodiment 1 | polymer film | Gorilla Glass | 3M 8215 | 651 | 2779 | 6842 | 13178 | 20057 |
| Comparative Example 1 | polymer film | Acryl Resin | 3M 8215 | 622 | 2687 | 6673 | 12795 | 19441 |
| Comparative Example 2 | polymer film | Soda Lime Glass | 3M 8215 | 603 | 2597 | 6397 | 12269 | 18546 |
| Reference 2 | paper | — | — | 554 | 2420 | 5848 | 11045 | 17237 |
| Comparative Example 3 | paper | Gorilla Glass | 3M 8215 | 619 | 2654 | 6490 | 12296 | 18868 |
| Comparative Example 4 | paper | Acryl Resin | 3M 8215 | 603 | 2596 | 6352 | 12040 | 18460 |
| Comparative Example 5 | paper | Soda Lime Glass | 3M 8215 | 559 | 2386 | 5788 | 10871 | 16913 |

Referring to Table 5, gamuts of Embodiment 1 at all saturations of S=0.2, 0.4, 0.6, 0.8, and 1.0 were widest. In other words, the area of the gamut of Embodiment 1 is greater than the areas of the gamuts of References 1 and 2 and Comparative Examples 1 through 5. Accordingly, the image frame of Embodiment 1 may express richer colors than the image frames of Comparative Examples 1 through 5.

### 6. Black and White Density Response

### Reference 3

Reference 3 was obtained by printing a gray scale patch for black and white density response measurement on a polymer film in which PP, PET, and PP are stacked on each other in this stated order by using an inkjet printer.

### Reference 4

Reference 4 was obtained by printing the same gray scale patch as that used for Reference 3 on paper instead of the polymer film.

### Embodiment 2

Similar to Reference 3, a gray scale patch for black and white density response measurement was printed on the polymer film in which PP, PET, and PP are stacked on each other in this stated order by using an inkjet printer, and then an OCA film was attached onto the gray scale patch according to a rolling method. As the OCA film, 8215, manufactured by 3M, with a thickness of 125 μm was used.

Then, an image frame was manufactured by attaching Gorilla® glass, manufactured by Corning Incorporated, with a thickness of 1.1 mm, as a glass cover layer, onto the OCA film by using a rolling method.

### Comparative Examples 7 through 11

Image frames were manufactured using the same methods as Comparative Examples 1 through 5 except that the same gray scale patch as that for Reference 3 is used instead of a sampling color patch.

<Measurement of Black and White Density Response>

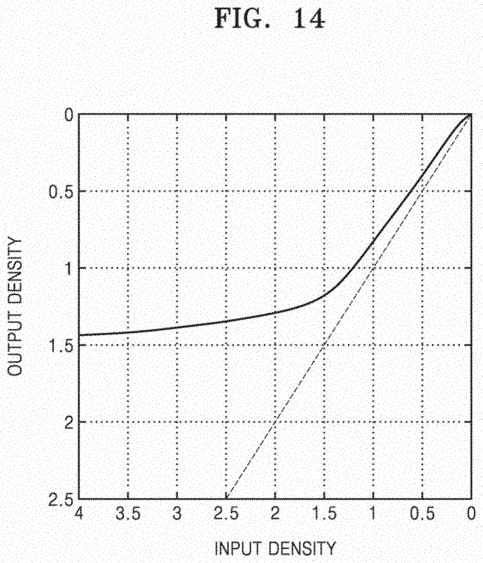

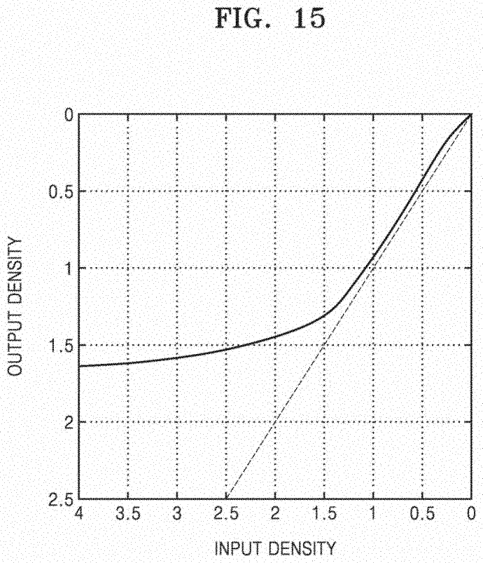

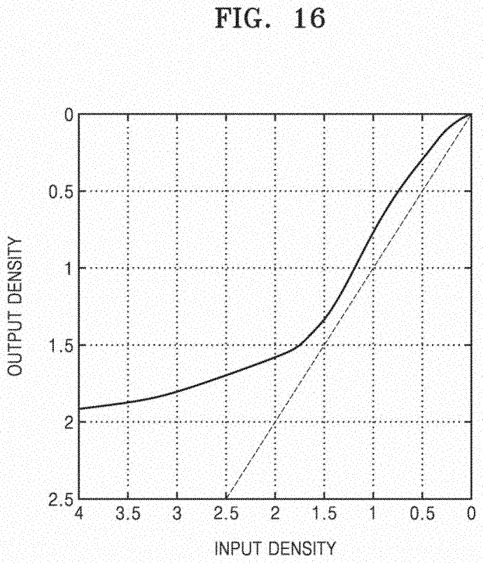

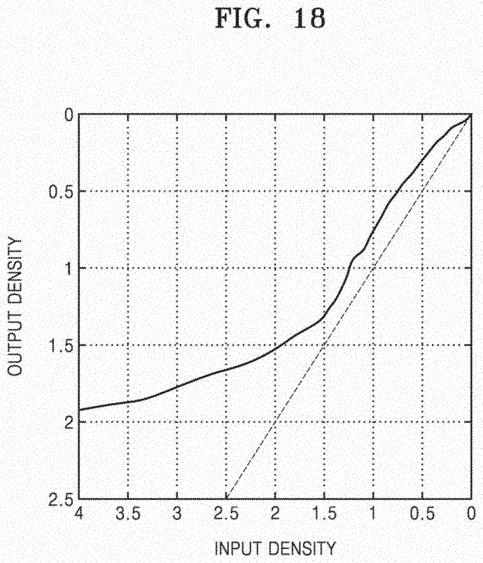

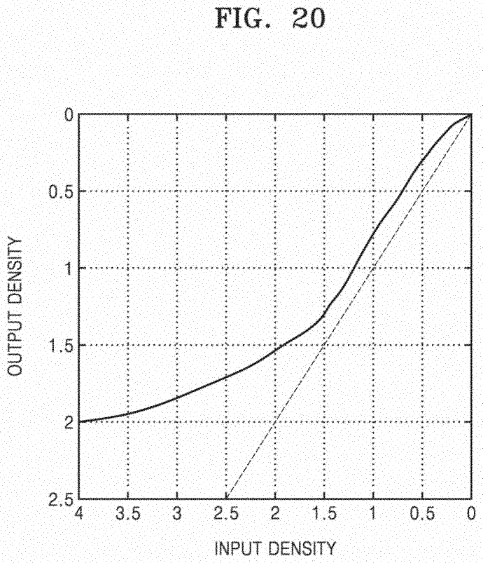

Black and white density responses of the objects of References 3 and 4, Embodiment 2, and Comparative Examples 7 through 11 were measured by using a spectrum photometer, and a result of the measurement is represented in FIGS. 14 through 21. In detail, FIGS. 14 and 15 are graphs showing results of measuring the black and white density responses of the objects of References 3 and 4, respectively. FIGS. 16 through 21 are graphs showing results of measuring the black and white density responses of the image frames of Embodiment 2 and Comparative Examples 7 through 11, respectively. In the graphs of FIGS. 14 through 21, an input density (horizontal axis) and an output density (vertical axis) of smaller value indicate being closer to white, and the input density (horizontal axis) and the output density (vertical axis) of greater value indicate being closer to black. In the graphs of FIGS. 14 through 21, as a curved line of a measurement value approaches a reference line (R) and becomes linear, a tone reproduction ability is good.

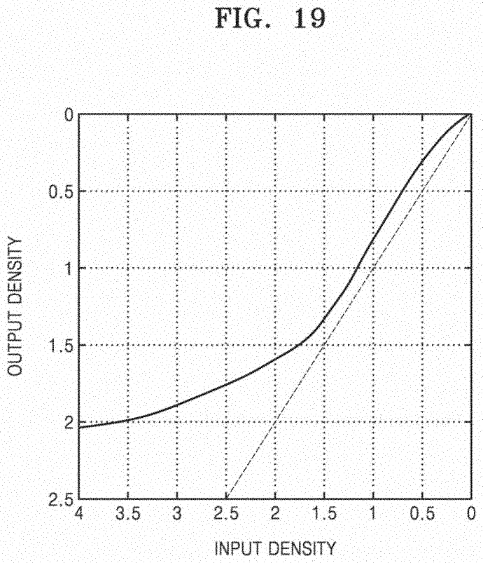

Referring to FIGS. 16 and 19, a good black and white dynamic range is shown, and the image frames of Embodiment 2 and Comparative Example 9 have high black and white density responses.

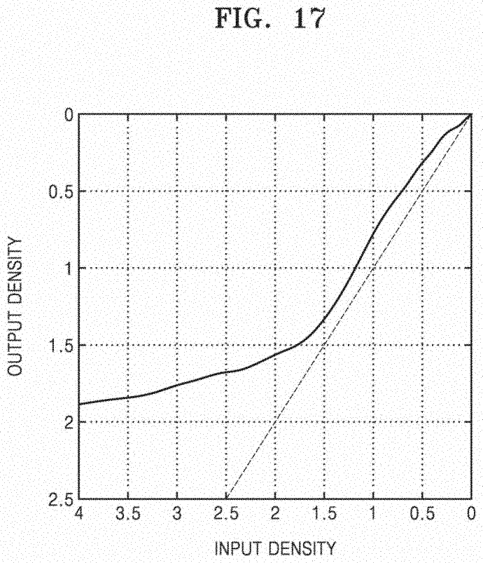

On the other hand, referring to FIGS. 17, 18 and 20, because a section in which a curved line of a measurement value rapidly changes intermittently without smoothly changing exists, a black and white expression may not be relatively smooth.

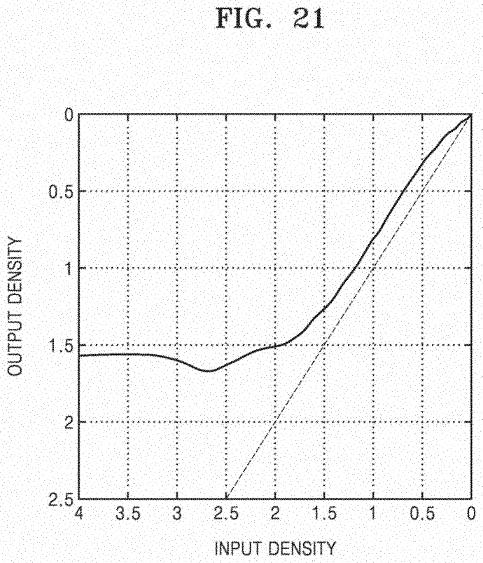

Referring to FIG. 21, because a curve line of a measurement value does not monotonically change but a direction in which the curve line of the measurement value changes is changed in a relatively dark region, a tone reproduction ability is bad.

### Comparative Example 12

Similar to Reference 1, a sampling color patch for CIE L-a-b 1976 modeling was printed on the polymer film in which PP, PET, and PP are stacked on each other in this stated order by using an inkjet printer, and then optical clear resin (OCR) was coated on the sampling color patch to have a certain thickness.

Then, an image frame was manufactured by attaching Gorilla® glass, manufactured by Corning Incorporated, with a thickness of 1.1 mm, as a glass cover layer, onto an OCR layer by using a rolling method and curing the OCR layer.

### 7. Surface Flatness and Evaluation of Image Quality

Surface flatness of a glass cover layer was measured for each of the image frames manufactured in Embodiments 1 and 2 and Comparative Example 12. Consequently, Embodiments 1 and 2 showed flatness of 0.30 mm or less and flatness of 0.28 mm, respectively, per length of 100 mm. The image frame of Comparative Example 12 showed flatness of 0.56 mm or less per length of 100 mm.

Image quality evaluation was performed on the image frames manufactured in Embodiments 1 and 2 and Comparative Example 12. Both an image of the sampling color patch used in Embodiment 1 and Comparative Example 12 and an image of the gray scale patch used in Embodiment 2 have lattice shapes, and visual distortion of an image according to surface irregularity was subjectively evaluated by focusing on straightness of the patterns of the sampling color patch and the gray scale patch. A criterion of the evaluation was quantified based on five points as follows.

Five points: Surface irregularity was not identified at all.

Four points: it cannot be said that no surface irregularity was identified.

Three points: surface irregularity was identified after close observation.

Two points: surface irregularity was felt through slight observation.

One point: Surface irregularity was identified at a glance.

28 evaluators were made subjectively evaluate the image frames of Embodiments 1 and 2 and Comparative Example 12 according to the aforementioned criterion. As a result of calculating an arithmetic mean of the scores given to each of the image frames by the evaluators, the image frame of Embodiment 1 gained a score of 4.8, the image frame of Embodiment 2 gained a score of 4.9, and the image frame of Comparative Example 12 gained a score of 3.3. In other words, it was confirmed that the image frames of Embodiments 1 and 2 were able to obtain smooth surfaces with less distortions compared with the image frame of Comparative Example 12.

### 8. Test of Adhesion and Preservability

The image frames manufactured in Embodiments 1 and 2 and Comparative Examples 1 through 5 were put into an oven maintaining a temperature of 70° C. and relative humidity of 90%, and preservability was tested for each of the image frames. It was inspected every 120 hours whether an edge or the like of each image frame has inter-layer bubbles or is peeled off, and a result of the inspection is expressed in Table 6.

TABLE 6

| | 1 | 2 | 3 | 4 | 5 | 6 | 7 | 8 | 9 | 10 | 11 | 12 | 13 | 14 |
|---|---|---|---|---|---|---|---|---|---|---|---|---|---|---|
| Embodiment 1 | ◯ | ◯ | ◯ | ◯ | ◯ | ◯ | ◯ | ◯ | ◯ | ◯ | ◯ | ◯ | ◯ | ◯ |
| Embodiment 2 | ◯ | ◯ | ◯ | ◯ | ◯ | ◯ | ◯ | ◯ | ◯ | ◯ | ◯ | ◯ | ◯ | ◯ |
| Comparative | ◯ | ◯ | ◯ | ◯ | ◯ | ◯ | ◯ | ◯ | ◯ | ◯ | ◯ | ◯ | ◯ | ◯ |
| Example 1 | | | | | | | | | | | | | | |
| Comparative | ◯ | ◯ | ◯ | ◯ | ◯ | ◯ | ◯ | ◯ | ◯ | ◯ | ◯ | ◯ | ◯ | ◯ |
| Example 2 | | | | | | | | | | | | | | |
| Comparative | ◯ | ◯ | ◯ | ◯ | ◯ | ◯ | ◯ | ◯ | ◯ | ◯ | ◯ | ◯ | ◯ | ◯ |
| Example 3 | | | | | | | | | | | | | | |
| Comparative | ◯ | ◯ | ◯ | ◯ | ◯ | ◯ | ◯ | ◯ | ◯ | ◯ | ◯ | ◯ | ◯ | ◯ |
| Example 4 | | | | | | | | | | | | | | |
| Comparative | ◯ | ◯ | ◯ | ◯ | ◯ | ◯ | ◯ | ◯ | ◯ | ◯ | ◯ | X | X | X |
| Example 5 | | | | | | | | | | | | | | |

x120 HRs

| | 15 | 16 | 17 | 18 | 19 | 20 | 21 | 22 | 23 | 24 | 25 | 26 | 27 | 28 | 29 |
|---|---|---|---|---|---|---|---|---|---|---|---|---|---|---|---|
| Embodiment 1 | ◯ | ◯ | ◯ | ◯ | ◯ | ◯ | ◯ | ◯ | ◯ | ◯ | ◯ | ◯ | ◯ | ◯ | ◯ |
| Embodiment 2 | ◯ | ◯ | ◯ | ◯ | ◯ | ◯ | ◯ | ◯ | ◯ | ◯ | ◯ | ◯ | ◯ | ◯ | ◯ |
| Comparative | ◯ | ◯ | ◯ | ◯ | ◯ | ◯ | ◯ | ◯ | ◯ | ◯ | ◯ | ◯ | X | X | X |
| Example 1 | | | | | | | | | | | | | | | |
| Comparative | ◯ | ◯ | ◯ | ◯ | ◯ | ◯ | ◯ | ◯ | ◯ | ◯ | X | X | X | X | X |
| Example 2 | | | | | | | | | | | | | | | |
| Comparative | ◯ | ◯ | X | X | X | X | X | X | X | X | X | X | X | X | X |
| Example 3 | | | | | | | | | | | | | | | |
| Comparative | ◯ | X | X | X | X | X | X | X | X | X | X | X | X | X | X |
| Example 4 | | | | | | | | | | | | | | | |
| Comparative | X | X | X | X | X | X | X | X | X | X | X | X | X | X | X |
| Example 5 | | | | | | | | | | | | | | | |

Referring to Table 6, it appeared that the image frames manufactured using a polymer film as a print medium of an image (Embodiments 1 and 2 and Comparative Examples 1 and 2) are generally good in adhesion and preservability compared with the image frames manufactured using paper (Comparative Examples 3, 4, and 5).

In detail, Embodiments 1 and 2 maintained good adhesion and good preservability until a test is completed. The image frames of Comparative Examples 1 and 2 using a polymer film were significantly good in adhesion and preservability compared with Comparative Examples 3 through 5 using a paper film, but were not good in adhesion and preservability compared with Embodiments 1 and 2.

Embodiments of the present disclosure provide an image frame that may be displayed in various forms without distortion and may be preserved long time without quality degradation, and a method of manufacturing the image frame.

According to an aspect (1) of the present disclosure, an image frame is provided. The image frame comprises: a polymer film comprising an image layer on a first main surface of the polymer film; a glass cover layer located over the first main surface of the polymer film with the image layer facing the glass cover layer; and an adhesive film between the polymer film and the glass cover layer, wherein a cubic L-a-b gamut volume according to CIE L-a-b 1976 modeling is 340,000 or greater.

According to an aspect (2) of the present disclosure, the image frame of aspect (1) is provided, wherein the glass cover layer comprises: SiO₂ of 60 mol % to 70 mol %; Al₂O₃ of 6 mol % to 14 mol %; B₂O₃ of 0 mol % to 15 mol %; Li₂O of 0 mol % to 15 mol %; Na₂O of 0 mol % to 20 mol %; K₂O of 0 mol % to 10 mol %; MgO of 0 mol % to 8 mol %; CaO of 0 mol % to 10 mol %; ZrO₂ of 0 mol % to 5 mol %; SnO₂ of 0 mol % to 1 mol %; Ceo₂ of 0 mol % to 1 mol %; As₂O₃ of less than 50 ppm; and Sb₂O₃ of less than 50 ppm, and wherein 12 mol %≤(Li₂O+Na₂O+K₂O)≤20 mol %, and 0 mol %≤(MgO+CaO)≤10 mol %.

According to an aspect (3) of the present disclosure, the image frame of aspect (2) is provided, wherein a difference between a maximum thickness and a minimum thickness of the glass cover layer is less than about 0.03 mm.

According to an aspect (4) of the present disclosure, the image frame of aspect (2) is provided, wherein a surface of the glass cover layer opposite to the surface of the glass cover layer facing the adhesive film has an unevenness of less than 0.03 mm.

According to an aspect (5) of the present disclosure, the image frame of aspect (2) is provided, wherein the polymer film comprises a polypropylene (PP) film or a polyethylene terephthalate (PET) film.

According to an aspect (6) of the present disclosure, the image frame of aspect (5) is provided, wherein the polymer film has a thickness of about 200 micrometers (μm) to about 350 μm.

According to an aspect (7) of the present disclosure, the image frame of aspect (2) is provided, wherein a hue-saturation-lightness (HSL) gamut volume according to CIE L-a-b 1976 modeling is 750,000 or greater.

According to an aspect (8) of the present disclosure, the image frame of aspect (2) is provided, wherein a white point L value according to CIE L-a-b 1976 modeling is about 72 to about 74.

According to an aspect (9) of the present disclosure, the image frame of aspect (2) is provided, wherein, by attaching the glass cover layer, an HSL gamut volume according to CIE L-a-b 1976 modeling increases by 250,000 or greater compared with when the glass cover layer is not attached.

According to an aspect (10) of the present disclosure, the image frame of aspect (2) is provided, wherein, by attaching the glass cover layer, a cubic L-a-b gamut volume according to CIE L-a-b 1976 modeling decreases by 100,000 or less compared with when the glass cover layer is not attached.

According to an aspect (11) of the present disclosure, the image frame of aspect (2) is provided, wherein, by attaching the glass cover layer, a white point L value according to CIE L-a-b 1976 modeling decreases by 21 or less compared with when the glass cover layer is not attached.

According to an aspect (12) of the present disclosure, an image frame is provided. The image frame comprises: a polymer film comprising an image layer on a first main surface of the polymer film; a glass cover layer located on the first main surface of the polymer film with the image layer facing the glass cover layer; and an adhesive film between the polymer film and the glass cover layer, a hue-saturation-lightness (HSL) gamut volume according to CIE L-a-b 1976 modeling is 750,000 or greater.

According to an aspect (13) of the present disclosure, the image frame of aspect (12) is provided, wherein the glass cover layer comprises: SiO₂ of 60 mol % to 70 mol %; Al₂O₃ of 6 mol % to 14 mol %; B₂O₃ of 0 mol % to 15 mol %; Li₂O of 0 mol % to 15 mol %; Na₂O of 0 mol % to 20 mol %; K₂O of 0 mol % to 10 mol %; MgO of 0 mol % to 8 mol %; CaO of 0 mol % to 10 mol %; ZrO₂ of 0 mol % to 5 mol %; SnO₂ of 0 mol % to 1 mol %; CeO₂ of 0 mol % to 1 mol %; As₂O₃ of less than 50 ppm; and Sb₂O₃ of less than 50 ppm, and wherein 12 mol %≤(Li₂O+Na₂O+K₂O)≤20 mol %, and 0 mol %≤(MgO+CaO)≤10 mol %.

According to an aspect (14) of the present disclosure, the image frame of aspect (13) is provided, wherein a white point L value according to CIE L-a-b 1976 modeling is about 72 to about 74.

According to an aspect (15) of the present disclosure, the image frame of aspect (13) is provided, wherein a surface of the glass cover layer opposite to the surface of the glass cover layer facing the adhesive film has an unevenness of less than 0.03 mm, the polymer film comprises a laminated film of a polypropylene (PP) film and a polyethylene terephthalate (PET) film, and the polymer film has a thickness of about 200 micrometers (μm) to about 350 μm.

According to an aspect (16) of the present disclosure, the image frame of aspect (15) is provided, wherein the adhesive film is an acryl-based adhesive film having a thickness of about 90 μm to about 130 μm.

According to an aspect (17) of the present disclosure, the image frame of aspect (16) is provided, wherein the adhesive film originates from a stand-alone type solid film.

According to an aspect (18) of the present disclosure, a method of manufacturing an image frame is provided. The method comprises: attaching an adhesive film onto an image layer of a polymer film, the polymer film including the image layer being at a first main surface; and attaching a glass cover layer onto the adhesive film, wherein the polymer film comprises a laminated film of a polypropylene (PP) film and a polyethylene terephthalate (PET) film, the adhesive film is an acryl-based adhesive film, and the glass cover layer comprises: SiO₂ of 60 mol % to 70 mol %; Al₂O₃ of 6 mol % to 14 mol %; B₂O₃ of 0 mol % to 15 mol %; Li₂O of 0 mol % to 15 mol %; Na₂O of 0 mol % to 20 mol %; K₂O of 0 mol % to 10 mol %; MgO of 0 mol % to 8 mol %; CaO of 0 mol % to 10 mol %; ZrO₂ of 0 mol % to 5 mol %; SnO₂ of 0 mol % to 1 mol %; CeO₂ of 0 mol % to 1 mol %; As₂O₃ of less than 50 ppm; and Sb₂O₃ of less than 50 ppm.

According to an aspect (19) of the present disclosure, the method of aspect (18) is provided, wherein the polymer film comprises a PP-PET laminated film in which a PP film is stacked on both surfaces of a PET film.

According to an aspect (20) of the present disclosure, the method of aspect (18) is provided, after the attaching of the adhesive film onto the image layer and the attaching of the glass cover layer onto the adhesive film, further comprising performing hot-pressing on the polymer film, the adhesive film, and the glass cover layer.

According to an aspect (21) of the present disclosure, the method of aspect (20) is provided, wherein the hot-pressing is performed at about 50° C. to about 90° C.

According to an aspect (22) of the present disclosure, the method of aspect (18) is provided, further comprising transferring the image layer onto the first main surface before attaching an adhesive film onto an image layer of a polymer film.

According to an aspect (23) of the present disclosure, the method of aspect (22) is provided, wherein the image layer is transferred via inkjet printing or laser printing.

According to an aspect (24) of the present disclosure, the method of aspect (18) is provided, wherein the attaching the adhesive film onto the image layer is performed by rolling the adhesive film and the image layer while a surface of the adhesive film facing the image layer.

While one or more embodiments have been described with reference to the figures, it will be understood by those of ordinary skill in the art that various changes in form and details may be made therein without departing from the spirit and scope of the present disclosure as defined by the following claims.

What is claimed is:

1. An image frame comprising:
a polymer film comprising an image layer on a first main surface of the polymer film;
a glass cover layer located over the first main surface of the polymer film with the image layer facing the glass cover layer; and
an adhesive film between the polymer film and the glass cover layer,
wherein a cubic L-a-b gamut volume according to CIE L-a-b 1976 modeling is 340,000 or greater.

2. The image frame of claim 1, wherein
the glass cover layer comprises:
SiO₂ of 60 mol % to 70 mol %;
Al₂O₃ of 6 mol % to 14 mol %;
B₂O₃ of 0 mol % to 15 mol %;
Li₂O of 0 mol % to 15 mol %;
Na₂O of 0 mol % to 20 mol %;
K₂O of 0 mol % to 10 mol %;
MgO of 0 mol % to 8 mol %;
CaO of 0 mol % to 10 mol %;
ZrO₂ of 0 mol % to 5 mol %;
SnO₂ of 0 mol % to 1 mol %;
CeO₂ of 0 mol % to 1 mol %;
As₂O₃ of less than 50 ppm; and
Sb₂O₃ of less than 50 ppm, and
wherein 12 mol %≤(Li₂O+Na₂O+K₂O)≤20 mol %, and
0 mol %≤(MgO+CaO)≤10 mol %.

3. The image frame of claim 2, wherein a difference between a maximum thickness and a minimum thickness of the glass cover layer is less than about 0.03 mm.

4. The image frame of claim 2, wherein a surface of the glass cover layer opposite to the surface of the glass cover layer facing the adhesive film has an unevenness of less than 0.03 mm.

5. The image frame of claim 2, wherein the polymer film comprises a polypropylene (PP) film or a polyethylene terephthalate (PET) film.

6. The image frame of claim 5, wherein the polymer film has a thickness of about 200 micrometers (μm) to about 350 μm.

7. The image frame of claim 2, wherein a hue-saturation-lightness (HSL) gamut volume according to CIE L-a-b 1976 modeling is 750,000 or greater.

8. The image frame of claim 2, wherein a white point L value according to CIE L-a-b 1976 modeling is about 72 to about 74.

9. The image frame of claim 2, wherein, by attaching the glass cover layer, an HSL gamut volume according to CIE L-a-b 1976 modeling increases by 250,000 or greater compared with when the glass cover layer is not attached.

10. The image frame of claim 2, wherein, by attaching the glass cover layer, a cubic L-a-b gamut volume according to CIE L-a-b 1976 modeling decreases by 100,000 or less compared with when the glass cover layer is not attached.

11. The image frame of claim 2, wherein, by attaching the glass cover layer, a white point L value according to CIE L-a-b 1976 modeling decreases by 21 or less compared with when the glass cover layer is not attached.

12. An image frame comprising:
a polymer film comprising an image layer on a first main surface of the polymer film;
a glass cover layer located on the first main surface of the polymer film with the image layer facing the glass cover layer; and
an adhesive film between the polymer film and the glass cover layer,
a hue-saturation-lightness (HSL) gamut volume according to CIE L-a-b 1976 modeling is 750,000 or greater.

13. The image frame of claim 12, wherein
the glass cover layer comprises:
SiO₂ of 60 mol % to 70 mol %;
Al₂O₃ of 6 mol % to 14 mol %;
B₂O₃ of 0 mol % to 15 mol %;
Li₂O of 0 mol % to 15 mol %;
Na₂O of 0 mol % to 20 mol %;
K₂O of 0 mol % to 10 mol %;
MgO of 0 mol % to 8 mol %;
CaO of 0 mol % to 10 mol %;
ZrO₂ of 0 mol % to 5 mol %;
SnO₂ of 0 mol % to 1 mol %;
CeO₂ of 0 mol % to 1 mol %;
As₂O₃ of less than 50 ppm; and
Sb₂O₃ of less than 50 ppm, and
wherein 12 mol %≤(Li₂O+Na₂O+K₂O)≤20 mol %, and
0 mol %≤(MgO+CaO)≤10 mol %.

14. The image frame of claim 13, wherein a white point L value according to CIE L-a-b 1976 modeling is about 72 to about 74.

15. The image frame of claim 13, wherein
a surface of the glass cover layer opposite to the surface of the glass cover layer facing the adhesive film has an unevenness of less than 0.03 mm,
the polymer film comprises a laminated film of a polypropylene (PP) film and a polyethylene terephthalate (PET) film, and
the polymer film has a thickness of about 200 micrometers (μm) to about 350 μm.

16. The image frame of claim 15, wherein the adhesive film is an acryl-based adhesive film having a thickness of about 90 μm to about 130 μm.

17. The image frame of claim 16, wherein the adhesive film originates from a stand-alone type solid film.

18. A method of manufacturing an image frame, the method comprising:
attaching an adhesive film onto an image layer of a polymer film, the polymer film including the image layer being at a first main surface; and
attaching a glass cover layer onto the adhesive film,
wherein the polymer film comprises a laminated film of a polypropylene (PP) film and a polyethylene terephthalate (PET) film,
the adhesive film is an acryl-based adhesive film, and
the glass cover layer comprises:
SiO₂ of 60 mol % to 70 mol %;
Al₂O₃ of 6 mol % to 14 mol %;
B₂O₃ of 0 mol % to 15 mol %;
Li₂O of 0 mol % to 15 mol %;
Na₂O of 0 mol % to 20 mol %;
K₂O of 0 mol % to 10 mol %;
MgO of 0 mol % to 8 mol %;
CaO of 0 mol % to 10 mol %;
ZrO₂ of 0 mol % to 5 mol %;
SnO₂ of 0 mol % to 1 mol %;
CeO₂ of 0 mol % to 1 mol %;
As₂O₃ of less than 50 ppm; and
Sb₂O₃ of less than 50 ppm.

19. The method of claim 18, wherein the polymer film comprises a PP-PET laminated film in which a PP film is stacked on both surfaces of a PET film.

20. The method of claim 18, after the attaching of the adhesive film onto the image layer and the attaching of the glass cover layer onto the adhesive film, further comprising performing hot-pressing on the polymer film, the adhesive film, and the glass cover layer.

21. The method of claim 20, wherein the hot-pressing is performed at about 50° C. to about 90° C.

22. The method of claim 18, further comprising transferring the image layer onto the first main surface before attaching an adhesive film onto an image layer of a polymer film.

23. The method of claim 22, wherein the image layer is transferred via inkjet printing or laser printing.

24. The method of claim 18, wherein the attaching the adhesive film onto the image layer is performed by rolling the adhesive film and the image layer while a surface of the adhesive film facing the image layer.
